(19) United States
(12) Patent Application Publication
(10) Pub. No.: US 2018/0263273 A1
(43) Pub. Date: Sep. 20, 2018

(54) HERB STRIPPER

(71) Applicant: Kitchen Innovations Inc., King City (CA)

(72) Inventor: Robert G. Dickie, King City (CA)

(73) Assignee: Kitchen Innovations Inc.

(21) Appl. No.: 15/461,720

(22) Filed: Mar. 17, 2017

(51) Int. Cl. A23N 15/02; A47J 17/00

(52) U.S. Cl. CPC A23N 15/02; A47J 17/00

(57) ABSTRACT

A herb stripper and method of use. The herb stripper includes a base with a plurality of differently sized holes therein and through which herb stems may be inserted and pulled to strip leaves from the stem. A cutting edge is provided adjacent each hole and may be around 0.001″ in width and oriented at an angle relative to an axis of the hole. The cutting edge may be protected by recessing the cutting edge relative to the surrounding surface or by providing a raised overmolded region on the surface adjacent the cutting edge, or by forming the hole and cutting edge in a depression formed in the surface of the base. A groove circumscribes the cutting edge and aids in diverting cut leaves away from the hole through which the stem is being pulled.

### BACKGROUND

### Technical Field

This invention is generally directed to kitchen utensils. More particularly, this invention relates to a device for stripping herbs. Specifically, this invention is a herb stripper that comprises a base with a plurality of differently sized holes therein and through which herb stems may be inserted and pulled to strip leaves from the stem. A cutting edge is provided adjacent each hole. The cutting edge may be less than 0.005″ in width, preferably around 0.001″ in width, and may be oriented at an angle relative to an axis of the associated hole. The cutting edge may be protected by recessing the cutting edge relative to the surrounding surface or by providing a raised overmolded region on the surface adjacent the cutting edge, or by forming the hole and cutting edge in a depression formed in the surface of the base.

### Background Information

Herbs greatly enhance the flavor of food and it is therefore common for chefs and home cooks to add them to dishes they are preparing. It is typically the leaves of a herb that are utilized for this purpose. A number of herbs, such as parsley and basil, for instance, have leaves that are relative easy to pluck from the stems to which they are attached. The stems themselves do not necessarily have to be separated entirely from the leaves because they are not woody in nature. Herbs such as rosemary and thyme, on the other hand, have small leaves that extend outwardly from woody stems. These stems cannot be cut up and added to a dish that is being prepared as the stems do not break down during cooking. It is therefore desirable for the leaves of these types of herbs to be plucked from the woody stems. However, because of the small size of some of the leaves involved, stripping the leaves from the woody stems can be a frustrating and time consuming task.

A number of low cost, injection molded plastic herb strippers have been proposed in the art to address this problem. Typically, these strippers include some type of base with about eight progressively larger holes provided therein. These tools typically include a base that is a fairly flat plastic shape of approximately 0.080″ to about 0.100″ in thickness. The holes defined in the base may have one side with a sharper edge radius of approximately 0.005″ for stripping the herb leaves off the stem of the plant. The stem to be stripped is inserted bottom end first into one of the holes that is slightly larger than the diameter of the stem itself. The stem is then pulled through the hole. The contact between the stem and the sharper edge defining the hole results in the leaves being stripped from the stem. The issue with most of these previously known herb strippers is that it is common for the stripped leaves to bunch up at the hole's edge and thereby increase the force required to pull the herb's stem therethrough.

### SUMMARY

There remains a need in the art for an improved tool for stripping herbs that addresses some of the issues with the prior art.

A herb stripper and method of use is disclosed herein which address some of the issues of the prior art devices. The herb stripper includes a base with a plurality of differently sized holes therein and through which herb stems may be inserted and pulled to strip leaves from the stem. A cutting edge is provided adjacent each hole and may be around 0.001″ in width and oriented at an angle relative to an axis of the hole. The cutting edge may be protected by recessing the cutting edge relative to the surrounding surface or by providing a raised overmolded region on the surface adjacent the cutting edge, or by forming the hole and cutting edge in a depression formed in the surface of the base. A groove circumscribes the cutting edge and aids in diverting cut leaves away from the hole through which the stem is being pulled.

In one aspect, the present disclosure may provide a herb stripper comprising a base having a top surface, a bottom surface and a peripheral wall extending between the top and bottom surfaces; a plurality of holes are defined in the base, each of the plurality of holes extending from the top surface through to the bottom surface; and wherein the holes progressively increase in diameter; a cutting edge formed on one of the top and bottom surfaces proximate an opening to each of the plurality of holes; and a groove defined in the one of the top and bottom surfaces outwardly of each cutting edge, wherein each cutting edge is positioned between an associated groove and an associated hole.

In another aspect, the present disclosure may provide a method of stripping leaves from a herb stem comprising providing a herb stripper having a base having a top surface, a bottom surface and a peripheral wall extending between the top and bottom surfaces; a plurality of differently sized holes defined in the base; a cutting edge formed on one of the top and bottom surfaces at an opening to each of the plurality of holes; and a groove defined in the base outwardly from the cutting edge, wherein the cutting edge is located between an opening to an associated hole and an associated groove; selecting one of the plurality of holes for insertion of the herb stem; inserting a bottom end of a herb stem into the opening of the selected one of the plurality of holes; pulling the bottom end of the herb stem; drawing the herb stem through the selected one of the plurality of holes; stripping leaves off the herb stem with the cutting edge; and diverting the stripped leaves outwardly away from the cutting edge and the opening and towards the associated groove.

The method may further include inserting blades of a pair of herb scissors into a clip provided on the base or through a hole defined in the base; and retaining the pair of herb scissors in the clip or the hole. The method may further include removing the pair of herb scissors from the clip or the hole; and cutting the herb stem or the stripped leaves into smaller pieces using the pair of herb scissors.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims.

FIG. 1 is a top perspective view of a herb stripper in accordance with an aspect of the present invention;

FIG. 2 is a top plan view thereof;

FIG. 3 is a bottom plan view thereof;

FIG. 4 is a right side elevation view thereof;

FIG. 5 is a cross-section of the herb stripper taken along line 5-5 of FIG. 3;

FIG. 6 is an enlarged cross-section of the highlighted region of FIG. 5;

FIG. 6A is an enlarged cross-section of the highlighted region of FIG. 5 showing the overmolding being raised relative to the associated top and bottom surfaces of the base instead of flush thereto as in FIG. 6;

FIG. 7 is a perspective view of a second embodiment of a herb stripper in accordance with an aspect of the present invention;

FIG. 7A is a cross-section of the herb stripper taken along line 7A-7A of FIG. 7;

FIG. 7B is an enlarged cross-section of the highlighted region of FIG. 7A; and

FIG. 8 is an enlarged cross-section of a hole in a PRIOR ART herb-stripping tool.

Similar numbers refer to similar parts throughout the drawings.

### DETAILED DESCRIPTION

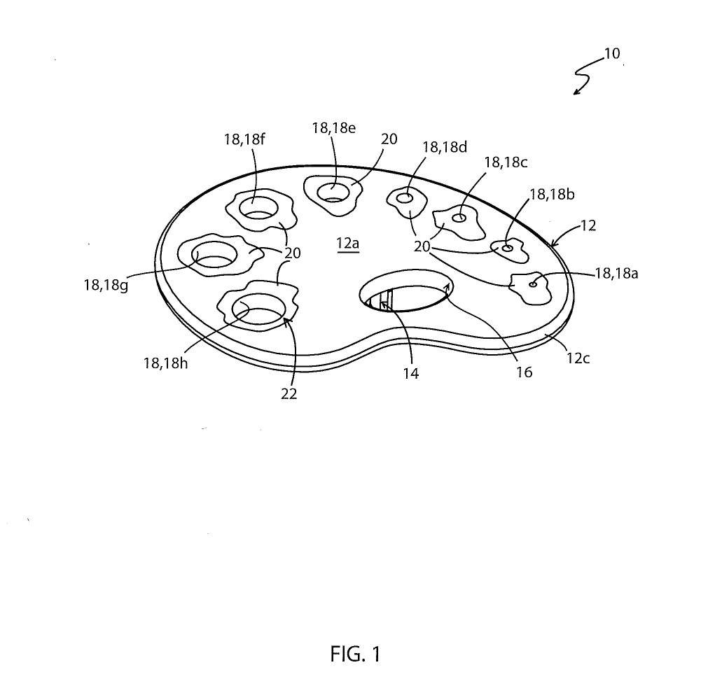

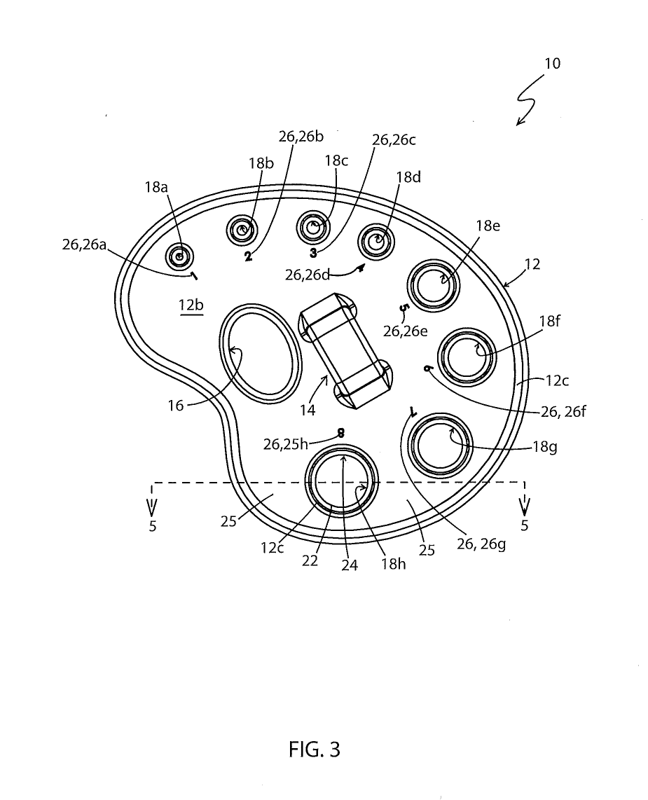

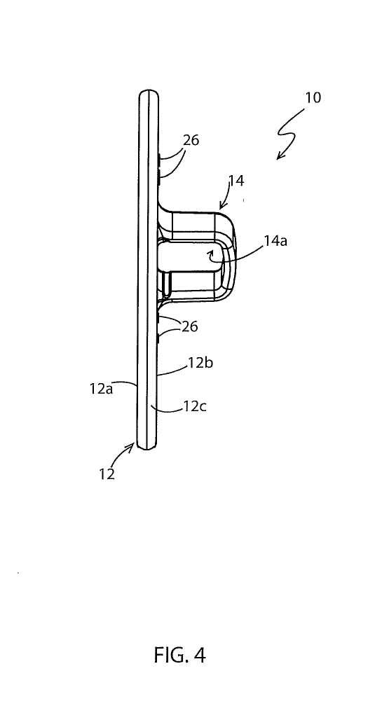

FIGS. 1-7B illustrate a herb stripping tool in accordance with an aspect of the present invention, generally indicated at 10. Tool 10 may comprise a base 12, a scissor clip 14 (FIGS. 3 and 4) that extends outwardly from the base 12, and a socket 16.

Base 12 comprises a generally planar member that has a top surface 12a, a bottom surface 12b (FIG. 3) and a peripheral edge 12c that extends between the top and bottom surfaces 12a, 12b. Base 12 may be fabricated from any suitable food-safe plastic material and may be fairly rigid so that the base 12 does not flex too much when it is used to strip herbs.

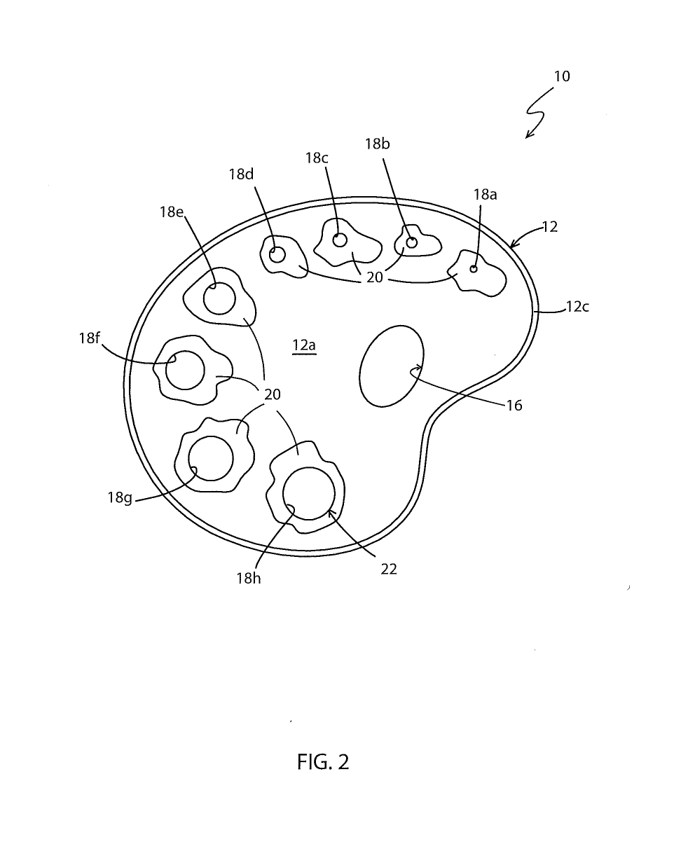

Base 12 may be shaped in a similar fashion to an artist's paint palette when top surface 12a is viewed from above as in FIG. 2. Peripheral edge 12c may therefore be curved around substantially the entire perimeter of base 12. Additionally, peripheral edge 12c may be rounded in a direction moving from top surface 12a to bottom surface 12b.

Scissor clip 14 may be molded from rubber and may be engaged with an extend outwardly away from bottom surface 12b of base 12. As best seen in FIG. 4, scissor clip 14 may be generally U-shaped when viewed from the side and may define a hole 14a therein. The blades of a pair of herb scissors may be received through hole 14a. Hole 14a may be of a size that is suitable to receive the blades of a pair of herb scissors therethrough. The size of hole 14a may further be of a size that does not permit the handle-end of the herb scissors therethrough. As such, scissor clip 14 may be utilized to hold a pair of herb scissors therein so that a user has all the tools required to strip herbs and to cut herbs into smaller pieces. Herb stripper 10 may be used for a first task of stripping the herbs and the stored herb scissors may be removed from scissor clip 14 for a second task of snipping or cutting the herbs.

Socket 16 comprises an aperture that is defined in base 12 and extends between top surface 12a and bottom surface 12b thereof. Socket 16 may be utilized to store a pair of herb scissors therein instead of using scissor clip 14. Socket 16 may be an aperture that is of a size suitable to receive the blades of the pair of herb scissors therethrough but is further of a size that prevents the handle-end of the herb scissors to pass therethrough. As with scissor clip 14, socket 16 may be utilized to retain and store the pair of herb scissors therein so that the scissors may be available to cut herbs to a smaller size when so desired. The pair of herb scissors may be stored in one or the other of scissor clip 14 or socket 16 when not in use, are withdrawn therefrom when a chef or cook desires to cut herbs into smaller pieces, and are subsequently re-engaged in scissor clip 14 of socket 16 when the scissors are no longer needed.

In accordance with an aspect of the invention, base 12 also defines a plurality of holes 18 therein. As illustrated in the attached figures, eight differently sized holes are defined in base 12. (It will be understood that fewer than eight holes 18 may be defined in base 12 or more than eight holes 18 may be defined therein.

Holes 18 are of different sizes so as to be able to strip different diameter stems. The smallest hole defined in base 12 is designated by the number 18a and the largest hole is designated by the number 18h. Holes 18a, 18b, 18c, 18d, 18e, 18f, 18g, and 18h progressively increase in size moving from hole 18a through to hole 18h.

The attached figures show that on top surface 12a holes 18 are surrounded by raised over-molded rubber regions 20. In other words, regions 20 may extend for a distance outwardly beyond top surface 12a of base 12. Regions 20 may be fabricated to appear as “paint splotches” to further enhance the aesthetics of the paint palette base 12. Each region 20 may be of a different color of rubber to further enhance the aesthetic of base 12. The over-molded rubber region 20 does, however serve an additional function and this is to disguise the holes 18.

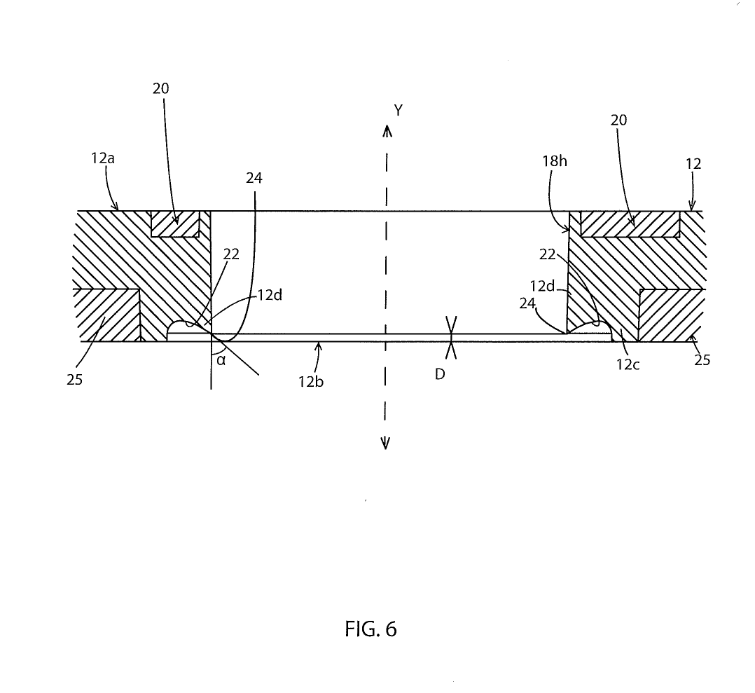

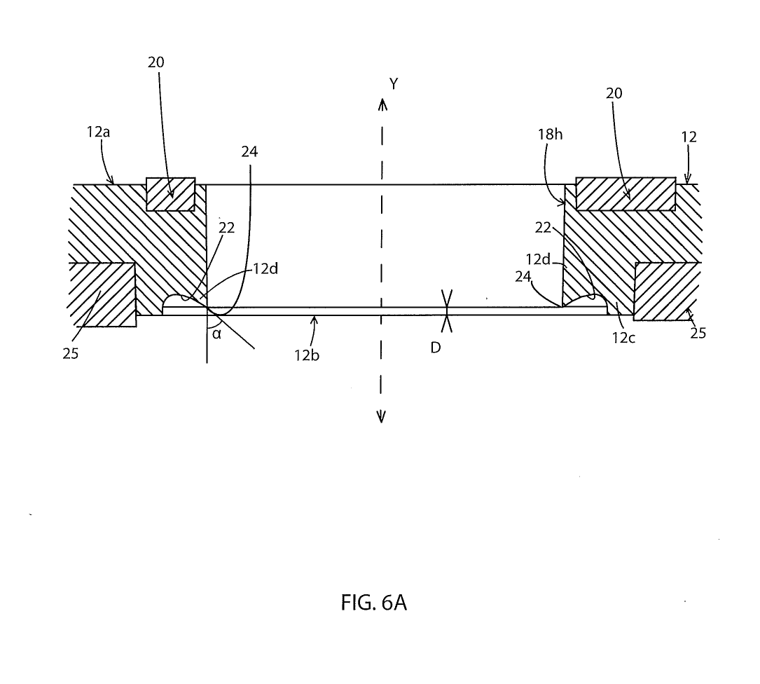

As best seen in FIG. 6, an annular groove 22 may be formed in lower surface 12b. Groove 22 may be concentric with the associated hole, 18h in this particular instance. A sharp cutting edge 24 may be formed between groove 22 and hole 18h. Groove 22 may be defined outwardly of cutting edge 24 proximate hole 18 such that each cutting edge 24 is positioned between an associated groove 22 and an associated hole 18 As is evident from FIG. 6, groove 22 may be shallower proximate cutting edge 24 and may become progressively deeper moving away from cutting edge 24 and outwardly toward a region 12c located between groove 22 and an over-molded region 25. Over-molded region 25 may raised or dome-shaped to protect cutting edge 24 from being damaged through inadvertent contact with a surface. It should be noted that region 12c may be an integral part of base 12 and therefore may be comprised of plastic. Over-molded region 25 may be comprised of a soft material such as a rubber. The rubber is raised relative to bottom surface 12b. The resilient rubber aids in absorbing accidental impacts with any other object and additionally, because the over-molded region 25 is raised, the over-molded region 25 will tend to be the area of base 12 that is impacted instead of having cutting edge 24 take an impact.

FIG. 6 also shows that cutting edge 24 is recessed a distance “D” inwardly from top surface 12a of base 12. Stripper 10 has an entrance to hole 18 with a sharp angled entrance of between 30 to 60 degrees and a cutting edge 24 with a cutting edge radius of less than 0.005″; and in particular from about 0.0011″ up to about 0.005″. Cutting edge 24 is configured as an apex of an apical region 12d the is formed when groove 22 is produced. Apical region 12d may be oriented at an angle α of from about 30° up to about 60° relative to an axis “Y” of hole 18. Apical region 12d may extend outwardly from a portion of the rest of base 12. Cutting edge 24 is therefore located between groove 22 and the associated hole, such as hole 18h. The positioning of the groove 22 and the recessed position of cutting edge 24 and groove 22 aids in ensuring leaf buildup is expelled and moved away from cutting edge 24 as cutting edge 24 strips leaves off a herb stem. The recessed groove 22 aids in ensuring that the expelled leaves are directed outwardly away from cutting edge 24 and in a direction outwardly away from the associated hole 18. Hole 18, such as hole 18h for example, has an axis “Y” (FIG. 6) that passes through the center of hole 18 and is oriented generally at right angles to top surface 12a and/or bottom surface 12b. The base 12 on at least one side of hole 18 may be provided with annular groove 22 and cutting edge 24. It will be understood, however, that the base at both of the sides of hole 18 may be provided with annular groove 22 and cutting edge 24. In other words, cutting edge 24 may be provided in upper surface 12a of base and/or bottom surface 12b of base.

FIG. 3 shows that indicia 26 may be provided on bottom surface 12b. In particular, the indicia 26 may be numbers provided on bottom surface 12b and adjacent to the hole in question. Each number 26 may represent a size of one of the plurality of holes 18. As illustrated in this figure, the smallest hole, 18a, is provided with a first number 26a. The first number 26a shown in the figure is the number “1”. The largest hole, 18h, is provided with a number 26h adjacent thereto. The number 26h in this particular instance is the number “8”. The numbers 26 may progressively increase in size from hole 18a to hole 18b. In particular, the numbers associated with the various holes 18 are as follows: 18a, 26a—the number “1”; 18b, 26b—the number “2”, 18c, 26c—the number “3”; 18d, 26d, —the number “4”, 18e, 26e—the number 5; 18f, 26f—the number 6; 18g, 26g, the number 7; and 18h, 26h—the number 8. Numbers 26a-26h may be raised relative to bottom surface 12b or may be flush therewith. The numbers 26a-26h may be overmolded onto bottom surface 12b or may be flush therewith in other instances. Still further, numbers 26 may simply be indicia marked onto bottom surface 12b by printing, for example, or by application of a decal.

Instructions as to how to use herb stripper 10 may also be provided on one or both of top and bottom surfaces 12a, 12b by printing thereon, or application of a decal thereto or by overmolding a resilient material to form the words of the instructions.

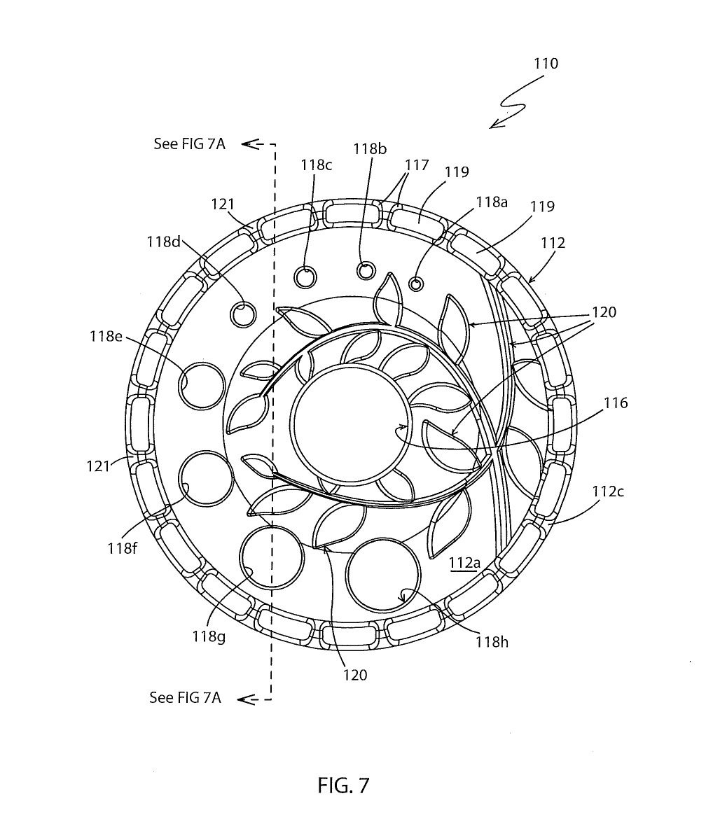

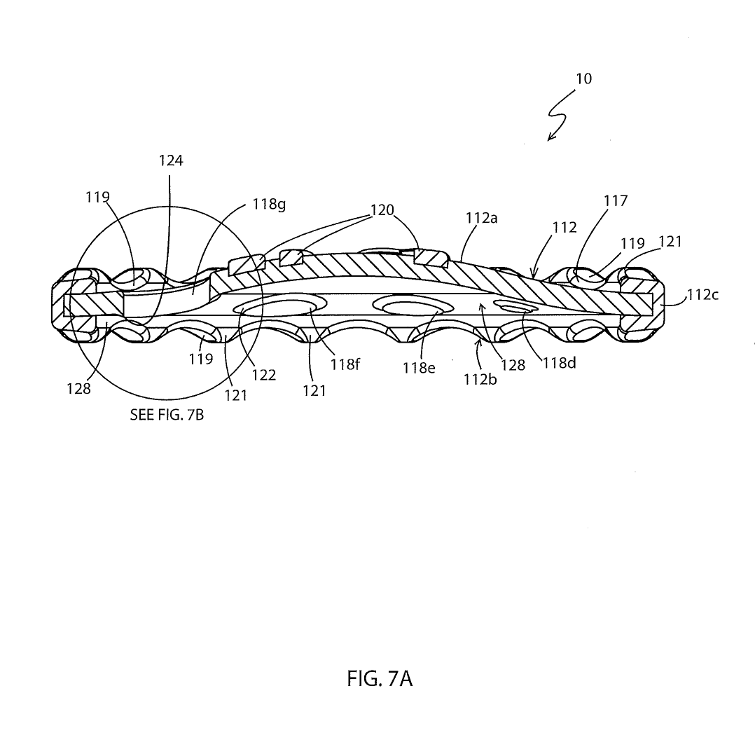

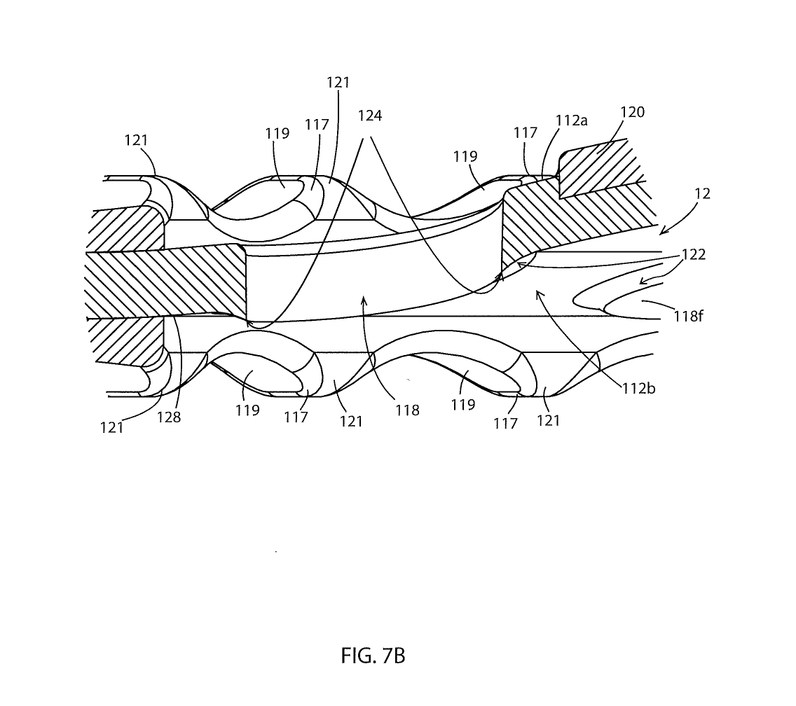

FIGS. 7, 7A and 7B show a second embodiment of a herb stripper in accordance with an aspect of the present invention, generally indicated at 110. Herb stripper 110 comprises a base 112 having a top surface 112a, a bottom surface 112b and a peripheral edge 112c extending between the top and bottom surfaces 112a, 112b. A plurality of progressively larger holes 118a-118h are defined in base 112 in a similar fashion to holes 18a to 18h of base 12. Each hole 118a-118h extends between top and bottom surfaces 112a, 112b.

Base 112 is illustrated may be generally disc-shaped or circular when viewed from the top although any other desired shape may be utilized. Peripheral edge 112c as illustrated may be generally circular. One or more gripping regions may be provided on base and these gripping regions may be provided on one or both of top surface 112a and bottom surface 112b. The gripping regions as illustrated may include a raised ridge 117 having an indentation 119 formed on its outermost surface. Adjacent raised ridges and indentations 117, 119 may be separated from each other by raised regions 121. The user may use ridges 117 and indentations 119 as guides for placement of their fingers to grasp base 112. The user may place his or her finger in an indentation 119 on top surfaces 112a and their thumb in an opposed indentation 119 on bottom surface 112b and grip base 112 therebetween.

A region of base 112 that defines each hole 118 may form a cutting edge 124 on at least bottom surface 112b. In other instances, a cutting edge 124 may also be formed in top surface 112a. Cutting edge 124 may be similar in structure and function, dimensions and orientation to cutting edge 24.

In order to protect cutting edge 124, hole 118 and cutting edge 124 may be provided within a recessed region 128 (FIGS. 7A, 7B) of base 112. The recessed region 128 may be a depression formed in bottom surface 112b or may be formed by the raised regions 117, 121 encircling bottom surface 112b. Recessed region 128 may circumscribe all of the holes 118a-118h or may partially or completely circumscribe at least a part of one associated hole 118. For instance, recessed region 128 may extend for from about 120° up to about 180° of a circumference of hole 118g. (It will be understood that recessed region 128 may, instead, extend for less than 120° around the circumference of hole 118 or may extend around substantially the entire circumference of hole 118 (i.e., through 360°). Recessed region 128 may aid in preventing damage to cutting edge 124 and therefore may aid in preventing reduced performance of herb stripper 10.

Just radially outside of cutting edge 124, a groove 122 may be defined in bottom surface 112b. Groove 122 may be similar to groove 22 and help to direct stripped leaves from a herb stem outwardly away from cutting edge 124. Groove 122 may therefore aid in stopping the build up of cut leaves around cutting edge 124 and hole 118. Groove 122 may therefore aid in preventing an increase in the force required to pull a herb stem through hole 118.

Overmolding 120, 125 may be provided on one or both of top surface 112a and 112b in a location proximate holes 118. Overmolding 120, 125 may be flush with top surface 112a or bottom surface 112b or may be raised relative to one or both surfaces 112a, 112b. Overmolding 120 is illustrated as being in the stylized form of leaves formed on top surface 112a. A similar pattern may be provided on lower surface 112b.

Although not illustrated herein, numbers similar to numbers 126 may be provided on base 112 or these numbers may be omitted therefrom.

Herb stripper 110 may be provided with a socket 116 in order to store a pair of herb scissors on herb stripper 110 in a similar manner to socket 116 in herb stripper 10. Although not illustrated herein, herb stripper 110 may additionally or alternatively be provided with a clip similar to clip 14 in order to store a pair of herb scissors with base 112.

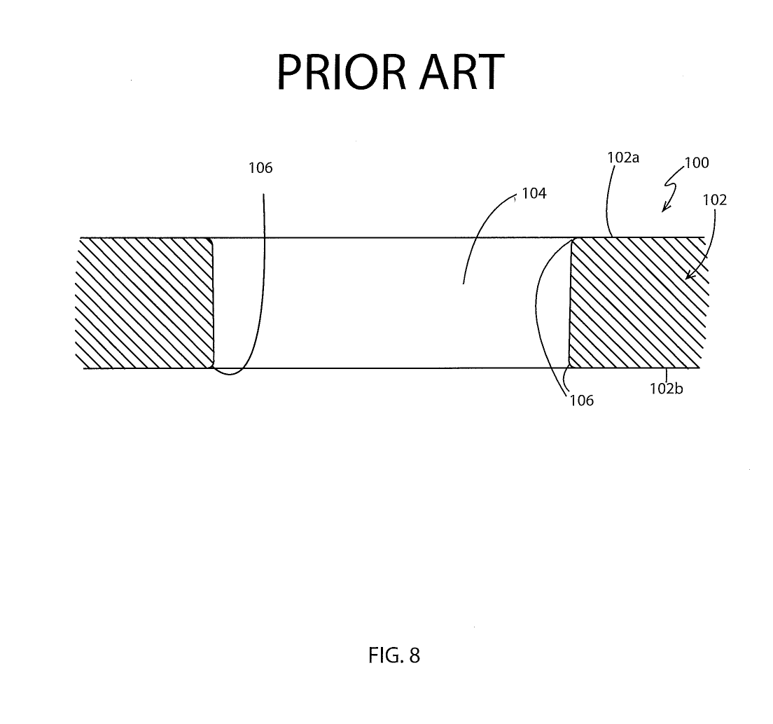

FIG. 8 shows a cross-section through a section of a PRIOR ART herb stripper 100. Herb stripper 100 comprises a planar member 102 that has a top surface 102a and a bottom surface 102b. A hole 104 is defined in planar member 102 and hole 104 extends from top surface 102a through to bottom surface 102b. Herb stripper 100 has about a 90 degree angle at the entrances to hole 102. Thus, the portions of top surface 102a and bottom surface 102b that define hole 104 tend to have slightly rounded edges, indicated at 106 These rounded edges 106 may strip some of the leaves off a herb stem that is fed through hole 104 but the leaves removed from the stem will tend to accumulate in and around hole 104 and thereby make it substantially harder for a user to pull the stem therethrough.

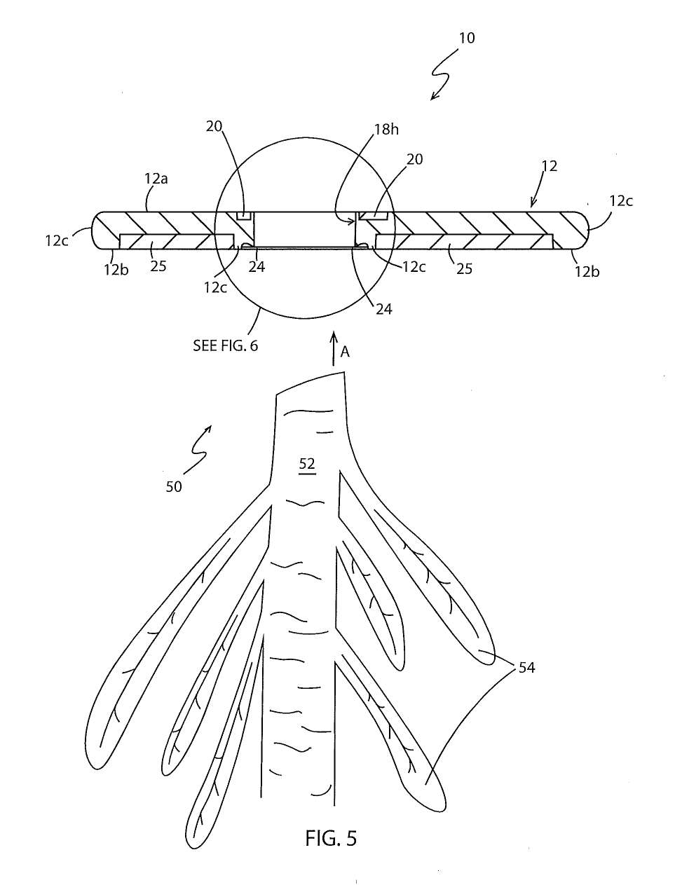

Referring to FIG. 5, herb stripper 10 may be used by first selecting a hole 18a-18a on herb stripper 10 to use to strip leaves 54 from a herb 50. The user will position herb 50 proximate bottom surface 12b of herb stripper 10, with the herb 50 oriented with the bottom end of its stem 52 closest to hole 18. The particular hole 18a through 18h selected for use is one where the hole's diameter is just slightly larger than the diameter of stem 52.

Once the bottom end of stem 52 is received through an opening to the selected hole 18a-18h, (such as hole 18h) the stem 52 is moved in the direction of arrow “A” (FIG. 5). Initially, the stem 52 may be pushed in the direction of arrow “A” but then the user will grasp the bottom end of stem 52 as it protrudes through the opening to the selected hole 18h in top surface 12a and will then pull stem 52 in the direction of arrow “A”.

As stem 52 is moved in the direction of arrow “A”, the exterior surface of stem 52 contacts the annular cutting edge 24 and some or all of the leaves 54 on stem 50 will be stripped therefrom. As leaves 54 are stripped from stem 52, the angled configuration of cutting edge 24 along with the presence of groove 22 causes the leaves 54 to be directed away from the opening to hole 18h in bottom surface 12b of base 12. As a consequence of the redirecting of the stripped leaves 54, by the angled cutting edge 24 and groove 22, the amount of force required to pull stem 52 through hole 18h remains substantially constant during the entire stripping process and tends not to increase.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the preferred embodiment of the disclosure are an example and the disclosure is not limited to the exact details shown or described.

1. A herb stripper comprising:
a base having a top surface, a bottom surface and a peripheral wall extending between the top and bottom surfaces;
a plurality of holes are defined in the base, each of the plurality of holes extending from the top surface through to the bottom surface; and wherein the holes progressively increase in diameter;
a cutting edge formed on one of the top and bottom surfaces proximate an opening to each of the plurality of holes; and
a groove defined in the one of the top and bottom surfaces outwardly of each cutting edge, wherein each cutting edge is positioned between an associated groove and an associated hole.

2. The herb stripper as defined in claim 1, wherein the cutting edge is an annular cutting edge that circumscribes the opening to the associated hole in the base.

3. The herb stripper as defined in claim 1, wherein the cutting edge is recessed inwardly relative to the one of the top and bottom surfaces.

4. The herb stripper as defined in claim 1, wherein the cutting edge and an opening to an associated hole in the one of the top and bottom surfaces is provided in a depression formed in the one of the top and bottom surfaces of the base.

5. The herb stripper as defined in claim 4, wherein the depression extends for from about 120° up to about 180° around the cutting edge.

6. The herb stripper as defined in claim 1, further comprising a raised region that at least partially circumscribes an adjacent hole; and wherein the raised region is located outwardly of the cutting edge such that each cutting edge is positioned between an associated hole and an associated raised region.

7. The herb stripper as defined in claim 6, wherein the raised region is fabricated through overmolding the base with a resilient material.

8. The herb stripper as defined in claim 1, wherein the cutting edge is provided on the bottom surface and wherein an overmolded rubber region is provided on one or both of the top surface of the base proximate an opening to the one or more of the plurality of holes.

9. The herb stripper as defined in claim 8, wherein the base is shaped as an artist's paint palette when viewed from above and the overmolded rubber region s provided on the top surface and has the appearance of paint splotches.

10. The herb stripper as defined in claim 1, wherein the base includes one or more raised gripping regions provided on one or both of the top and bottom surfaces thereof.

11. The herb stripper as defined in claim 1, wherein the cutting edge has a width of less than 0.005″.

12. The herb stripper as defined in claim 11, wherein the cutting edge has a width of about 0.001″.

13. The herb stripper as defined in claim 1, wherein the cutting edge is oriented at an angle of from about 30° up to about 60° relative to a hole axis, where the hole axis extends through a center of the hole and is oriented at right angles to the one of the top and bottom surfaces.

14. The herb stripper as defined in claim 1, further comprising indicia provided on one of the top and bottom surfaces adjacent the cutting edge.

15. The herb stripper as defined in claim 14, wherein the indicia are numbers, each number representing a size of one of the plurality of holes.

16. The herb stripper as defined in claim 1, further comprising a clip provided on one of the top or bottom surfaces of the base.

17. The herb stripper as defined in claim 16, wherein the clip is a U-shaped member that extends outwardly from the one of the top or bottom surfaces, and the U-shaped member defines a hole therein; and wherein the hole is of a size suitable to receive blades of a pair of herb scissors therein but is not of a size that will allow a handle-end of the pair of herb scissors to pass therethrough.

18. The herb stripper as defined in claim 1, further comprising a socket defined in the base, wherein the socket comprises an aperture that extends between the top and bottom surfaces of the base and is of a size suitable to receive blades of a pair of herb scissors therein but is not of a size that will allow a handle-end of the pair of herb scissors to pass therethrough.

19. A method of stripping leaves from a herb stem comprising:
providing a herb stripper having a base having a top surface, a bottom surface and a peripheral wall extending between the top and bottom surfaces; a plurality of differently sized holes defined in the base; a cutting edge formed on one of the top and bottom surfaces at an opening to each of the plurality of holes; and a groove defined in the base outwardly from the cutting edge, wherein the cutting edge is located between an opening to an associated hole and an associated groove;
selecting one of the plurality of holes for insertion of the herb stem;
inserting a bottom end of a herb stem into the opening of the selected one of the plurality of holes;
pulling the bottom end of the herb stem;
drawing the herb stem through the selected one of the plurality of holes;
stripping leaves off the herb stem with the cutting edge; and
diverting the stripped leaves outwardly away from the cutting edge and the opening and towards the associated groove.

20. The method as defined in claim 19, further comprising:
inserting blades of a pair of herb scissors into a clip provided on the base or through a hole defined in the base; and
retaining the pair of herb scissors in the clip or the hole.

21. The method as defined in claim 20, further comprising:
removing the pair of herb scissors from the clip or the hole; and
cutting the herb stem or the stripped leaves into smaller pieces using the pair of herb scissors.
